(19) United States
(12) Patent Application Publication
(10) Pub. No.: US 2012/0003483 A1
(43) Pub. Date: Jan. 5, 2012

(54) SCRATCH-RESISTANT AND EXPANDABLE CORROSION PREVENTION LAYER FOR LIGHT METAL SUBSTRATES

(76) Inventors: Dirk Salz, Bremen (DE); Klaus-Dieter Vissing, Morsum (DE)

(21) Appl. No.: 12/740,022

(22) PCT Filed: Oct. 31, 2008
(86) PCT No.: PCT/EP08/64826

§ 371 Date: Jun. 23, 2010

(30) Foreign Application Priority Data
Oct. 31, 2007 (DE) 10 2007 000 611.1

(51) Int. Cl. B32B 15/08; B32B 15/20; B05D 3/00; B05D 3/06; B05D 5/00

(52) U.S. Cl. 428/447; 427/489

(57) ABSTRACT

The present invention relates to a method for coating the surface of a light metal substrate, including the following steps:
A. preparing the light metal substrate and optionally cleaning the substrate surface to be coated,
B. coating the substrate surface optionally cleaned in step A in a plasma polymerization reactor by means of plasma polymerization, wherein
   one or more organosilicon and also (a) no further or (b) further compounds are used in step B as the precursor(s) for the plasma and
   in step B the light metal substrate is arranged in the plasma polymerization reactor in such a way that it (i) is located between the zone in which the plasma is formed and the cathode or (ii) acts as a cathode,
      characterized in that the method is conducted in such a way that the coating produced by the method displays
   a carbon content, which can be determined by XPS measurement, of from 5 to 20 atom %, preferably 10 to 15 atom %, based on the total number of carbon, silicon and oxygen atoms contained in the coating,
   a yellow index, determined in accordance with ASTM D 1925, of ≦3, preferably ≦2.5 and
   a hardness, to be measured by means of nanoindentation, in the range of from 2.5 to 6 GPa, preferably 3.1 to 6 GPa.

The invention relates to a method for coating the surface of a light metal substrate, in particular aluminum and magnesium, with a layer distinguished by an advantageous combination of scratch resistance, expandability and corrosion preventiveness, and also to coated light metal substrates.

Untreated surfaces of objects (for example semifinished products) made of light metals, in particular of aluminum (including aluminum alloys) or magnesium (including magnesium alloys), display high corrodibility, in particular in specific media, such as for example lyes or acids. In addition, their mechanical stability is comparatively low. Aluminum surfaces (optionally finished by a chemical, electrochemical or mechanical pretreatment), in particular, are therefore often treated by anodizing (anodizing method, anodic oxidation, anodization). As a result, the top layer of the metal is transformed into an oxide layer in a controlled manner. Corresponding anodized surfaces have, on account of the transparency of the oxide layer generated, a metallic luster and are protected, compared to non-treated surfaces, in a certain manner from corrosion and scratching. Anodized layers typically have an open-pored surface structure. Dyes can optionally be introduced into the pores. In many cases, the openings of the anodizing pores are closed by compacting. For this purpose, hydrous aluminum oxide is conventionally formed in the pore; this improves corrosion prevention and longevity. Anodized layers form an integral part of aluminum and therefore do not flake or chip off.

However, anodized layers have the drawback of displaying low expandability. A crack onset strain (strain to microcracking) of about 0.4%, which is thus worse than in untreated aluminum, is typical. This is highly restrictive in the processing of corresponding components from aluminum or aluminum alloys (aluminum substrates), for example in the case of car trims. Even very slight bending, for example on account of an at least 1 m-long trim being secured at just one end, causes hairline cracks in an anodized layer. Such cracks also frequently occur when a component of this type falls to the ground from working height. Hairline cracks are also observed during heating to above approx. 100° C., such as regularly occurs during welding or hot bending, for example. In the event of a rise in temperature of this type, the structure of the material is altered; this can become visible during anodizing and lead to a non-decorative appearance. The corrosion preventiveness of the anodized layer, in particular, fails at the points at which hairline cracks run.

Furthermore, although anodizing improves the corrosion resistance of the surface of an aluminum substrate over the untreated aluminum substrate, it is not sufficient for all areas of application. Anodized layers provide only inadequate protection, in particular against the attack of strong bases (pH of about 13.5 or higher).

As a result, anodized surfaces no longer fulfill the current requirement profile in certain areas of industrial application such as the automotive industry, for example. The scratch resistance of an anodized surface is increased over the surface of an untreated aluminum substrate, but not to a sufficient degree for all areas of application (for example not for trims, covers, lights, fittings and food processing machine parts).

An example of diverse surface stresses which a surface treated by an anodizing method is in many cases unable to withstand may be found, again, in the automotive sector, for example in the case of aluminum wheel rims. If wheel rims of this type are, in order to obtain their metallic luster, not to be painted after polishing, then this necessitates a method for generating coatings which do not change, or change only slightly the visual appearance, offer good corrosion prevention, do not tend to form cracks under mechanical compressive and tensile stresses, display high scratch resistance, are not subverted in the event of local destruction, are as insensitive as possible to lyes and detergents, reproduce the surface effectively and also display high thermal stability and optionally dirt-repelling surface behavior, so that no brake dust can become attached, for example.

The object of the present invention was to specify a method which can be used to generate on an aluminum substrate a protective layer which does not display, or at least displays to a reduced extent, some or all the above-described drawbacks of anodized layers. In particular, a layer of this type should display improved crack onset strain. Furthermore, improved chemical stability in relation to alkaline media and also generally improved corrosion preventiveness compared to anodized layers is desirable. Furthermore, a layer of this type should have improved scratch resistance compared to anodized layers and be able to be produced in an economically advantageous process, in particular at comparatively high speed.

It has surprisingly been found that this object is achieved by a method for coating the surface of a light metal substrate, including the following steps:
A. preparing the light metal substrate and optionally cleaning the substrate surface to be coated,
B. coating the substrate surface optionally cleaned in step A in a plasma polymerization reactor by means of plasma polymerization, wherein one or more organosilicon and also (a) no further or (b) further compounds are used in step B as the precursor(s) for the plasma and in step B the light metal substrate is arranged in the plasma polymerization reactor in such a way that it (i) is located between the zone in which the plasma is formed and the cathode or (ii) acts as a cathode,
   characterized in that the method is conducted in such a way that the coating produced by the method displays
   a carbon content, which can be determined by XPS measurement, of from 5 to 20 atom %, preferably 10 to 15 atom %, based on the total number of carbon, silicon and oxygen atoms contained in the coating,
   a yellow index, determined in accordance with ASTM D 1925, of ≦3, preferably ≦2.5 and
   a hardness, to be measured by means of nanoindentation, in the range of from 2.5 to 6 GPa, preferably 3.1 to 6 GPa.

The term “light metal” in the sense of the present invention refers to a metallic material having a specific density of at most 4.5 g/cm³. These include in particular magnesium, aluminum, beryllium and titanium and also alloys thereof. Preferred light metal substrates are magnesium substrates and in particular aluminum substrates.

A coating produced using the method according to the invention is distinguished by a hitherto unknown advantageous combination of properties that were previously considered to be mutually exclusive, namely good scratch and corrosion resistance at high expandability (crack onset strain of preferably greater than or equal to 1%, in particular greater than or equal to 1.5%). In addition, the method is according to the invention also allows good substrate adhesion, good optical transparency in the visible range and/or high layer thickness homogeneity to be achieved.

Coatings having a yellow index of 2.5 or less generally do not display any yellowing that is discernible to the human eye. However, in coatings provided as a substitute for anodized layers, minimal yellowing, as in a yellow index in the range of from above 2.5 to 3, is also tolerable. Furthermore, the yellow index is determined substantially by the content of Si—H bonds in the coating produced using the method according to the invention; this content is, as will be discussed hereinafter, decisive for achieving beneficial ranges of hardness and elasticity and thus for achieving the advantageous combination of properties.

A further important parameter is the carbon content of the coating produced by the method according to the invention, which content is influenced by the content of organic groups. Again, this content is also important for the hardness and elasticity of the coating, which is likewise desired for achieving the advantageous combination of properties. High elasticity of the coating enables the coating to be stretched together with the coated object, for example, without the formation of cracks. If the coating is very elastic, the substrate can even be plastically deformed without the coating becoming damaged. To a certain extent, this allows processes for reshaping the coated material.

In the coatings which can be produced by the method according to the invention, the scratch resistance, the crack onset strain and the corrosion prevention properties are improved compared to the anodized layers typical of aluminum. The scratch resistance of the layers is in many cases comparable to that of glass surfaces. It has surprisingly been found that the use of the (dry chemical) method according to the invention allows (wet chemical) anodizing to be dispensed with altogether. This is advantageous, as anodizing is, owing to the high use of energy, an expensive method which is problematical from environmental points of view. In addition, the method according to the invention places less stringent demands on the quality of the aluminum substrate, as it is not necessary to use anodizing-quality material. However, an anodized surface can also be coated; this can be desirable in particular in the case of dyed anodized layers. This improves the scratch resistance and the corrosion prevention properties in particular. In addition, dirt-repelling (low-energy) surface properties can be set at the surface of the coating. The achievable layer property function is of interest not only as an anodized substitute, but also for the general coating of light metals.

DE 197 48 240 A1 discloses a method for the corrosion-resistant coating of metal substrates, in particular made of aluminum or aluminum alloys, by means of plasma polymerization. At least one hydrocarbon or organosilicon compound is used as the precursor(s). DE 197 48 240 A1 does not contain any information concerning the content of the carbon atoms in the plasma polymer coatings produced or concerning the yellow index thereof. The layers disclosed therein effectively protect the surface from corrosion without optically altering it. However, one restriction is their low scratch resistance. The low deposition rates make the method disclosed therein unsuitable for economically producing higher layer thicknesses such as are necessary for scratch prevention coatings. It also places very high demands on the surface roughness of the substrate.

WO 03/002269 A2 discloses articles comprising a substrate and a plasma polymer O, C and Si-comprising coating which is connected to the substrate in a planar manner, in which the substance amount ratios of O to Si and C to Si are in each case in specific ranges, and which is easily cleanable. However, at least 25 atom %, the coatings disclosed therein have a higher carbon content than the coatings which can be produced by the method according to the invention, and do not display the above-mentioned combination of beneficial properties. Nor is there any mention of the yellow index to be set.

Domingues et al. (2002) Electrochimica Acta 47, 2253-2258 discloses an aluminum alloy with a plasma polymer coating which causes a certain corrosion prevention (detected by electrochemical impedance spectroscopy). However, the disclosed coating lacks in particular the good scratch resistance and the high expandability that are inherent properties of the coating according to the invention. Furthermore, it is distinguished by high absorption of water, comparable to that of organic coatings. Domingues et al. does not contain any information concerning yellowing or concerning the carbon content. On account of the manner in which the method is conducted (ratio of the gas flows of oxygen to the organosilicon precursor of about 23:1; see below for more detailed information on the influence of these parameters), the coating disclosed in Domingues et al. has a lower carbon content than the coating produced by the method according to the invention.

EP 0 748 259 B1 discloses coatings for soft substrates. It is not disclosed that the coatings might be suitable to protect aluminum substrates from corrosion. However, the coatings disclosed in EP 0 748 259 B1, which display a yellow index of ≦3, have a nanoindentation hardness of less than 2.5 GPa.

Nor is it taught to monitor the amount of non-stoichiometric silicon and thus the formation of Si—H in order to generate particularly hard (well-crosslinked), expandable layers with low yellowing. The optimized crosslinking ensures optimized corrosion prevention behavior.

Although thick layer methods, for example the application of paints or sol-gel coatings, can achieve the necessary corrosion resistance, they change the visual appearance. This effect is heightened still further in the case of non-uniformities such as for example in the event of mechanical damage or lack of adhesion of the thick layers.

The method according to the invention is able to meet the demand for an inexpensive method for generating a thin layer which does not change the surface color of aluminum (does not have any inherent color and thus has sufficiently high trans-mission in the visible range), which reproduces the surface structure (for example polished, ground, matted), so that no “gloss” is produced, which has, in addition to high corrosion stability, high mechanical resistance (scratch resistance, expandability) and which displays high layer thickness uniformity even in the case of complex geometries.

The layer properties may be set within broad limits by varying method parameters, as described hereinafter.

An increase in self-bias increases in this case the hardness of the layer, its optical absorption in the visible range (and thus the yellow index) and its corrosion preventiveness.

Setting the hardness of the coatings which can be produced by the method according to the invention allows the person skilled in the art to achieve an optimum with regard to the scratch resistance of the coating: If the hardness is too low, then the deposited plasma polymer layer is not sufficiently scratch-resistant. However, in the case of excessively high hardness, the scratch resistance also decreases, as the layer then becomes too brittle. Generally, the scratch resistance of the layer is determined by the suitable selection of the layer thickness and composition. Preference is given to a method according to the invention which is conducted in such a way that the coating produced by the method displays a pencil hardness of 4H or more, determined in accordance with ASTM D 3362. The measurement of hardness by means of nanoindentation is described in Example 2.

When setting the self-bias, it is also necessary to take account of the composition of the gas mixture from which the plasma is generated. Thus, for example, a lower self-bias must generally be selected at a high molecular mass of a precursor than at a low molecular mass. The more easily ionizable a precursor is, the lower the plasma power has to be in order to achieve a specific self-bias. At a high electrical conductivity of the plasma, a low plasma power is required in order to achieve a predefined self-bias.

Preference is given to a method according to the invention wherein a control is conducted during step B, so that the self-bias is in the range of from 50 to 1,000 V, preferably in the range of from 100 to 400 V, preferably in the range of from 100 to 300 V.

The self-bias can be reduced while the plasma power remains constant, for example, in that the plasma excitation frequency is increased.

An increase in the self-bias also causes an improvement of the layer thickness homogeneity. Thus, for example, tests carried out by the inventors revealed that, on a round substrate having a diameter of 10 cm, the maximum layer thickness is can differ from the minimum layer thickness at 100 V of self-bias by a factor of 1.1, whereas this factor may be 1.005 at 200 V of self-bias.

In the method according to the invention, in step B the light metal substrate is arranged in the plasma polymerization reactor in such a way that it either (i) is located between the zone in which the plasma is formed and the cathode or (ii) acts as a cathode. Alternative (ii) is in this case preferred. The substrate acts as a cathode when it is in direct electrically conductive contact with the part of the cathode that is distinguishable from the light metal substrate or when it is at a sufficiently short distance therefrom. This facilitates the achieving of a high deposition rate of the positively charged ions of the plasma, which are drawn toward the negatively charged cathode. When the substrate itself acts as a cathode, the impact with which the positively charged ions strike the surface is particularly increased. This changes the construction of the layer toward a lower content of organic groups (generally consisting predominantly of C and H) and an accordingly higher content of Si and O. The same effect also occurs (optionally in reduced form) when the substrate does not act as a cathode, but is arranged in the path of acceleration of the cations.

Without wishing to be bound by a particular theory, it is assumed that an increased impact, resulting from an intensified ion bombardment, for example, facilitates the elimination of organic groups both in the layer-forming ions and in the coating which is produced, the eliminated groups being less likely to be incorporated into the layer. In addition, the impact of the impinging ions reduces the internal tension (inherent tensions) of the layer; this increases the strain to microcracking of the layer. With regard to the measurement of the strain to microcracking (crack onset strain), compare Example 1.

The same observations (higher deposition rate, lower content of organic groups, lower internal tension, higher crack onset strain) are made when the self-bias is increased. For this reason, hard coatings can display a higher crack onset strain than soft coatings. In the case of very low self-bias, there is no sufficient impact which relieves the tension on the coating; this can lead to soft (for example hardness, to be measured by nanoindentation, of 1 GPa) and at the same time crack-sensitive coatings.

If, nevertheless, the self-bias is increased beyond an advantageous range (see in this regard also above), this produces coatings having an excessively low content of organic groups and an excessively high content of Si—H bonds (see in this regard also below), as a result of which they become excessively hard and excessively brittle and their scratch resistance decreases. It is thus desirable to achieve an optimum with regard to the hardness and elasticity of the coating produced by the method according to the invention at an acceptable yellow index (see in this regard also below).

An increase in self-bias causes in the layer which is produced on the one hand the reduction of inherent tensions and thus an effect increasing the crack onset strain, on the other hand an increase in hardness and the modulus of elasticity and thus an effect reducing the crack onset strain. The fact that two opposing effects partially cancel each other out produces an optimum of the crack onset strain as a function of the self-bias, thus allowing an outstanding combination of in each case comparatively high hardness and high crack formation to be generated.

In addition, an increase in self-bias leads to an increased deposition rate and improved corrosion resistance in the resulting layer.

The layers which can be generated using the method according to the invention are organically modified SiO₂ structures. The organic contents are detectable in the IR spectrum through bands at approx. 2,950 cm⁻¹ and at approx. 1,275 cm⁻¹. In addition, they can be detected by measuring the surface energy using test inks. The higher the content of organic groups is, the lower the surface energy is. Therefore, the higher the self-bias is set, the greater the surface energy is.

In the prior art, it is generally not preferable to arrange the substrate in a manner such that it acts as a cathode, as this harbors the risk of the formation of undefinable organosilicon layers on the substrate and is at odds with the wish for a relatively high content of organic groups in the layer. The organic modification increases the flexibility and elasticity of the layer which is generated. In addition, it reduces its inherent tensions (internal tension), as a result of which the crack onset strain of the layer is increased.

Preferably, in a method according to the invention, the self-bias on the substrate is set during step B. The dependency of the deposition rate and the layer properties on the self-bias has already been described. If the self-bias is set directly on the substrate and thus on the object to be coated, then this makes it easier to achieve a layer having the desired precisely defined properties.

Preferably, in a method according to the invention, a control is carried out during step B, so that the self-bias is constant. This allows the construction of the layer to be precisely monitored. Advantages of a self-bias that is as constant as possible are a homogeneous layer construction and a simple transfer of the process to various types of substrates or a plurality of substrates. Preferably, the self-bias is controlled straight away during step B. If the plasma power is controlled, then the self-bias will generally not be entirely constant, but rather fluctuate by a specific value. In such a case, it is preferable if the total fluctuation width of the self-bias is at most 5% of the mean time value, preferably at most 3%.

Particular preference is given to a method according to the invention (in particular in combination with one or more features of another method described as being preferred or particularly preferred), a control being conducted during step B, so that the self-bias on the substrate is in the range of from 50 to 1,000 V, preferably in the range of from 100 to 400 V, more preferably in the range of from 100 to 300 V, in particular in such a way that the self-bias is constant.

Preference is given to a method according to the invention wherein in step B the light metal substrate is in spatial contact with (i) the cathode or (ii) a part of the cathode that is distinguishable from the light metal substrate. Alternative (ii) relates, in contrast to alternative (i), to the case in which the substrate itself acts as a cathode. The production of a spatial contact facilitates the arrangement of the substrate in the plasma polymerization reactor.

An increase in the inflow of organosilicon precursor(s) for the plasma (in relation to optionally also inflowing O₂, in particular while keeping the total inflow constant) generally causes a reduction in hardness, an increase in absorption in the visible range (increase in the yellow index), an impairment of the corrosion preventiveness and an improvement of the crack onset strain.

At a high number of Si—H bonds in a layer according to the invention, increased absorption of light of the ultraviolet and blue spectral range can be ascertained in the UV/Vis spectrum. This leads to undesirable yellowing (increase in the yellow index). It is therefore desirable not to let the content of Si—H bonds become too great. A reduction in self-bias prevents the formation of Si—H bonds in the coating. The formation of Si—H bonds may also be inhibited by suitably selecting the quantity and/or type of precursor(s). This is generally achieved by reducing the inflow of organosilicon precursors which, in addition, also reduces the content of organic groups in the coating. The occurrence of Si—H bonds is also detectable in the IR spectrum (2,150 to 2,250 cm⁻¹).

The formation of Si—H bonds in the coating is also reduced if a sufficient amount of oxygen is supplied to the plasma; in addition, this also reduces the content of organic groups in the coating. Preference is given to a method according to the invention wherein in step B oxygen (in the form of O₂) is supplied to the plasma and preferably all the substances supplied to the plasma in step B are gaseous before entering the plasma polymerization reactor. Conducting the method in a manner such that the substances supplied to the plasma are gaseous not only under the conditions of the plasma, but even before entering the reactor, facilitates the precise adaptation of the metering of the substances.

An increase in the inflow of oxygen leads to an increase in hardness, a reduction of absorption in the visible range (reduction of the yellow index), to an improvement of corrosion preventiveness, to a reduction of the contents of organic groups in the coating and to a lowering of crack onset strain.

In a preferred method according to the invention, oxygen (O₂) is supplied to the plasma, all the substances supplied to the plasma in step B are gaseous before entering the plasma polymerization reactor and the ratio of the gas flows, supplied to the plasma in step B, of oxygen and further precursor(s) (in particular organosilicon precursors) is in the range of from 1:1 to 6:1, preferably 3:1 to 5:1. According to the invention, it is particularly simple in this range to set the desired content of carbon in the coating produced by the method and to achieve the desired properties of the coating.

If a yellow coating is obtained in a given set of parameters, then the O₂ flow can be increased. Alternatively, the inflow of organosilicon precursor(s) or the self-bias can be reduced. If the coating is excessively hard and thus excessively brittle, then the self-bias can be reduced or the inflow of organosilicon precursor(s) can be increased.

Preference is given to a method according to the invention, in particular in one of the configurations designated as being preferred, wherein one or more siloxanes, optionally oxygen (O₂) and also preferably no further compounds are used in step B as the precursor(s) for the plasma. Siloxanes, in particular hexamethyldisiloxane (HMDSO), have proven to be particularly suitable precursors in order to conduct a method according to the invention allowing coatings having the advantageous combination of properties to be produced. Preferably, in a method according to the invention, HMDSO, optionally oxygen and also preferably no further compound is used in step B as the precursor(s) for the plasma. An increase in the inflow of HMDSO in relation to oxygen causes inter alia a lowering in hardness, an increase in absorption in the visible range and an impairment of corrosion preventiveness.

Particular preference is given to a method according to the invention in which in step B oxygen is supplied to the plasma, all the substances supplied to the plasma in step B are gaseous before entering the plasma polymerization reactor, the ratio of the gas flows, supplied to the plasma in step B, of oxygen and further precursor(s) is in the range of from 1:1 to 6:1 and HMDSO, oxygen and also in particular no further compound is used as the precursor(s) for the plasma.

Preferably, in the method according to the invention, the plasma polymerization is carried out at a temperature of less than 200° C., preferably less than 180° C. and/or a pressure of less than 1 mbar, preferably in the range of from 10⁻³ to 10⁻¹ mbar. If the pressure is too high during the deposition, an undesirable powder formation of the deposited material can occur. At a temperature of greater than 180° C., the aluminum becomes softer and softer, as the crystal structure changes. At a pressure of less than 10⁻³ mbar, the plasma can no longer be ignited.

Preferably, in a method according to the invention, step B is carried out up to a thickness of the deposited coating of greater than or equal to 2 μm, preferably greater than or equal to 4 μm. A higher thickness increases the scratch preventiveness of a given coating.

Preference is given to a method according to the invention wherein in step B the deposition rate is set to a value of greater than or equal to 0.2 μm/min, preferably greater than or equal to 0.3 μm/min. A value of 0.5 μm/min can for example be selected. High deposition rates on the one hand increase the economic efficiency of the method according to the invention and in addition facilitate the setting of the desired layer properties.

Preferably, in a method according to the invention, the light metal substrate is an aluminum substrate selected from the group of substrates consisting of: aluminum or aluminum alloy having a cleaned, uncoated surface; aluminum or aluminum alloy having a superficial oxide layer; anodized aluminum or aluminum alloy having a dyed or undyed, compacted or uncompacted oxide layer. The aluminum or the aluminum alloy having a cleaned, uncoated surface is optional mechanically and/or electrically brightened and/or scoured or finished by a chemical, electrochemical or mechanical pretreatment, for example scoured, electropolished or polished. In addition, other light metals, such as for example magnesium and alloys thereof, may also be preferred as substrates. Even substrates of this type can be modified prior to the coating according to the invention by smoothing or conversion methods.

It is advantageous to conduct the method according to the invention in such a way that in step A the substrate surface to be coated is cleaned by means of a plasma. A plasma cleaning of this type improves layer adhesion. Preferably, in the method according to the invention, a gas or gas mixture is added in step A to the plasma for carrying out the plasma cleaning, the gas or gas mixture being selected from the group consisting of: argon, argon-hydrogen mixture, oxygen.

In some cases, it is advantageous to conduct the method according to the invention in such a way that following step B the plasma polymerization reactor contains non-fragmented organosilicon compounds which react with reactive sites at the surface of the coating so as to form a hydrophobic surface. This can be achieved in that, after the plasma source has been switched off, the unfragmented organosilicon precursor(s) are firstly left in the reactor and are in this way given the opportunity to react with the surface radicals of the plasma polymer layer. This allows the production of layers which are particularly simple to clean. The formation of a hydrophobic layer close to the surface can be detected by means of XPS. When the method is conducted in this way, a layer produced using the method according to the invention preferably contains in the upper 5 nm (remote from the substrate) a carbon content of 40-55 atom %, a silicon content of 15-25 atom % and an oxygen content of 20-35 atom %, based on the total number of Si, C and O atoms contained in the coating. It will in this regard be clear to the person skilled in the art that this superficial region is applied only after the steps which are essential to the invention have been carried out.

In the method according to the invention, the plasma is generated preferably by means of high frequency (HF). Plasmas generated by means of medium frequency, for example, frequently lead to coatings which are excessively brittle.

For a particularly preferred method according to the invention, the following applies:
in step B oxygen is supplied to the plasma;
all the substances supplied to the plasma in step B are gaseous before entering the plasma polymerization reactor;
the ratio of the gas flows, supplied to the plasma in step B, of oxygen and further precursor(s) are in the range of from 1:1 to 6:1;
a control is carried out during step B, so that the self-bias on the substrate is in the range of from 100 to 400 V, preferably in such a way that the self-bias is constant;
hexamethyldisiloxane (HMDSO), oxygen and preferably no further compound is used as the precursor(s) for the plasma;
in step B the light metal substrate is in spatial contact with a part of the cathode that is distinguishable from the light metal substrate;
the plasma polymerization is carried out at a temperature of less than 200° C. and a pressure in the range of from 10⁻³ to 10⁻¹ mbar;
in step B the deposition rate is set to a value of greater than or equal to 0.2 μm/min;
step B is carried out up to a thickness of the deposited coating of greater than or equal to 2 μm;
the light metal substrate is an aluminum substrate selected from the group of substrates consisting of: aluminum or aluminum alloy having a cleaned, uncoated surface; aluminum or aluminum alloy having a superficial oxide layer; anodized aluminum or aluminum alloy having a dyed or undyed, compacted or uncompacted oxide layer,
or the light metal substrate is a magnesium substrate selected from the group of substrates consisting of: magnesium or magnesium alloy having a cleaned, uncoated surface; magnesium or magnesium alloy having a superficial oxide layer.
in step A the substrate surface to be coated is cleaned by means of a plasma, a gas or gas mixture being added to the plasma for carrying out the plasma cleaning, the gas or gas mixture being selected from the group consisting of: argon, argon-hydrogen mixture, oxygen;
the plasma is generated by means of high frequency.

According to a further aspect, the present invention also relates to a coated light metal substrate, preferably a magnesium or an aluminum substrate, which can be produced using the method according to the invention, preferably in one of the configurations designated hereinbefore as being preferred.

Preferably, in a coated light metal substrate according to the invention, the coating displays contents, which can be measured by XPS measurement, of from 5 to 30 atom %, preferably 10 to 25 atom % of silicon and 30 to 70 atom %, preferably 40 to 60 atom % of oxygen, based on the total number of carbon, silicon and oxygen atoms contained in the coating. It is particularly readily possible to set the desired combination of properties in these atomic percent ranges. The dependency of the carbon, silicon and oxygen contents on the arrangement of the substrate and on the self-bias has been described hereinbefore. In addition, these contents can be influenced by selecting suitable precursors.

In a preferred coated light metal substrate according to the invention, an IR spectrum absorbed by the coating displays one or more, preferably all the following bands (peaks) having a respective maximum in the following ranges: C-H stretching vibration in the range of from 2,950 to 2,970 cm⁻¹, Si—H vibration in the range of from 2,150 to 2,250 cm⁻¹, Si—CH₂—Si vibration in the range of from 1,350 to 1,370 cm⁻¹, Si—CH₃ bending vibration in the range of from 1,250 to 1,280 cm⁻¹ and Si—O vibration at greater than or equal to 1,150 cm⁻¹.

The position of the maximum of the Si—O—Si vibration provides information about the degree of crosslinking of the layer. The higher its wave number is, the higher the degree of crosslinking is. Layers in which this maximum is greater than or equal to 1,200 cm⁻¹, preferably greater than or equal to 1,250 cm⁻¹, have a high degree of crosslinking, whereas antistick layers, for example, having this maximum at typically approx. 1,100 cm⁻¹ have a low degree of crosslinking.

A detectable Si—CH₂—Si vibrational band indicates that, in addition to Si—O—Si linkages, Si—CH₂—Si linkages are present in the coating. A material of this type often displays increased flexibility and elasticity.

The ratio of the intensity of the Si—H band to the intensity of the Si—CH₃ band can serve to characterize the coating. Coatings in which this ratio is less than or equal to approx. 0.2 are colorless. At a ratio of greater than approx. 0.3, the coatings are yellowish. Preference is given to a coated light metal substrate according to the invention wherein in an IR spectrum absorbed by the coating the ratio of the intensity of the Si—H band to the intensity of the Si—CH₃ band is less than or equal to 0.3, preferably less than or equal to 0.2.

Preference is given to a coated light metal substrate according to the invention wherein the coating displays an absorption constant k_{300 nm} of less than or equal to 0.05 and/or an absorption constant k_{400 nm} of less than or equal to 0.01. The relationship of the number of Si—H bonds causing absorption of light in the ultraviolet and blue range to the self-bias, a supply of oxygen to the plasma and the quantity and type of precursor(s) has been described hereinbefore.

Preferably, the coating of a coated light metal substrate according to the invention displays a surface energy in the range of from 20 to 40 mN/m, preferably 25 to 35 mN/m. The surface energy is determined, as stated above, by the contents of organic groups and thus by the amount of self-bias.

As stated hereinbefore, the corrosion prevention properties of the coating can be set by setting the self-bias, the inflows of organosilicon precursor(s) and of oxygen, for example. Preferably, a coated light metal substrate according to the invention displays after a 15-minute corrosive attack of NaOH at pH 14 and 30° C. no traces of corrosion that are visible to the naked eye.

As stated above, the crack onset strain is determined inter alia by setting the self-bias. In a preferred light metal substrate according to the invention, the coating displays a strain to microcracking (crack onset strain) of greater than or equal to 1%, preferably greater than or equal to 1.5%.

The self-bias influences the layer thickness homogeneity in the above-mentioned manner. However, the gas flows are also very important in the case of larger reactors. Examples of these include reactors of the type in which the reactor chamber is (recipient) is 2 m³ or greater. The layer thickness homogeneity, among other things, is defined by the electrical fields generated on the substrate, i.e. a high field strength means a high deposition rate. Homogeneity is achievable only when the electrical field strength is substantially the same everywhere on the substrate. The following generally applies: The layer thickness homogeneity on any desired three-dimensional substrate complies with the Laplace equation which indicates the solution for the electrical field strength on the substrate. Preferably, in a coated light metal substrate according to the invention, the maximum layer thickness differs from the minimum layer thickness by a factor of 1.1 or less.

According to a further aspect, the present invention also relates to the use of a coating which can be produced by a method according to the invention (in particular in a configuration designated as being preferred) as a substitute for an anodized layer.

Further aspects of the present invention emerge from the following examples, the drawings and the claims.

### EXAMPLES

### Example 1

### XPS

XPS measurements (ESCA measurements) were carried out using the KRATOS AXIS Ultra spectrometer from the company Kratos Analytical. The calibration of the measuring apparatus was carried out in such a way that the aliphatic content of the C 1s peak is at 285.00 eV. On account of charge effects, it will generally be necessary to shift the energy axis to this fixed value without further modification. The analysis chamber was equipped with an X-ray source for monochromatized Al K_{α} radiation, an electron source as a neutralizer and a quadrupole mass spectrometer. Furthermore, the installation had a magnetic lens which focused the photoelectrons into a hemispherical analyzer via an inlet slot. During the measurement the surface normal pointed onto the inlet slot of the hemispherical analyzer. The pass energy was in each case 160 eV when determining the substance amount ratios. The pass energy was in each case 20 eV when determining the peak parameters.

The aforementioned measuring conditions are preferred in order to allow substantial independence of the type of spectrometer and to identify plasma polymer products according to the invention.

The polydimethylsiloxane silicone oil DMS-T23E from the company Gelest Inc. (Morrisville, USA) was used as the reference material. This trimethylsiloxy-terminated silicone oil has a kinematic viscosity of 350 mm²/s (±10%) and a density of 0.970 g/ml at 25° C. and also an average molecular weight of approx. 13,650 g/mol. The selected material is distinguished by an extremely low content of vaporable constituents: after 24 hours at 125° C. and 10⁻⁵ torr of vacuum, less than 0.01% of volatile contents were detected (in accordance with ASTM-E595-85 and NASA SP-R0022A). The material was applied to a silicon wafer as a 40 or 50 nm-thick layer with the aid of a spin coating process; hexamethyldisiloxane was in this case used as a solvent.

The above-described procedure produces the following atomic composition for the silicone oil DMS-T23E. The binding energies of the electrons are also listed.

TABLE 1
Chemical composition and binding energy of silicone oil DMS-T23E

| | Element | | |
|---|---|---|---|
| | Si | O | C |
| Concentration | 24.76 | 25.40 | 49.84 |
| [atom %] | | | |
| Binding Energy | 102.39 | 532.04 | 285.00 |
| [eV] | | | |

### Example 2

### Measurement of the Hardness by Means of Nanoindentation

The nanoindentation hardness of a sample was determined with the aid of a Berkovich indenter (manufacturer: Hysitron Inc. Minneapolis, USA). The calibration and evaluation took place using the established method of Oliver & Pharr (J. Mater. Res. 7, 1564 (1992)). The machine rigidity and the surface function of the indenter were calibrated prior to the measurement. During the indentation the multiple partial unloading method (Schiffmann & Küster, Z. Metallkunde 95, 311 (2004)) was used to obtain depth-dependent hardness values and in this way to be able to rule out a substrate influence.

### Example 3

### Strain to Microcracking

A 0.5 mm-thin and 10 cm-long coated aluminum sheet is stretched until cracks become visually discernible. The crack onset strain limit is equal to the quotient of the change in length relative to the total length of the aluminum.

### Example 4

### IR Spectroscopy and Determining the Intensity Ratio of Two Bands in the IR Spectrum

The measurements were carried out using an IFS 66/S IR spectrometer from the company Bruker. The method used was the IRRAS technique which can be used to measure even very thin coatings. The spectra were absorbed in the wave number range from 700 to 4,000 cm⁻¹. Small platelets of very clean and particularly flat aluminum were used as the substrate material. The angle of incidence of the IR light was 50° during the measurement. While the sample was in the IR spectrometer, the sample chamber was purged continuously with dry air. The spectrum under such conditions recorded that the water vapor content of the sample chamber was so low that the IR spectrum displayed no rotational bands of water. An uncoated aluminum platelet was used as the reference.

The intensity ratio of two bands (peaks) is determined as follows: The baseline in the region of a peak is defined by the two minima enclosing the maximum of the band and corresponds to the distance between them. It is assumed that the absorption bands are Gaussian. The intensity of a band corresponds to the area between the baseline and measurement curve, bounded by the two minima enclosing the maximum, and can easily be determined by the person skilled in the art using known methods. The intensity ratio of two bands is determined by forming the quotient of their intensities. The basic requirement for the comparison of two is samples is in this case that the coatings display the same thickness and that the angle of incidence is not altered.

### Exemplary Embodiments 1 to 4

An anodized aluminum strip as the substrate is additionally provided with a transparent, expandable scratch and corrosion-resistant coating.

The substrate is fastened to or in the immediate vicinity of the cathode which is operated at HF (13.56 MHz) (surface area approx. 15×15 cm), so that the substrate itself acts as a cathode. After the rectangular low-pressure reactor having a volume of approx. 360 l and an installed nominal throughput of 4,500 m³/h has been evacuated to a pressure of less than 0.02 mbar, oxygen having a flow rate of 280 sccm is introduced into the reactor. A self-bias voltage of 250 V is set on the substrate with the aid of a high-frequency plasma discharge (13.56 MHz). These conditions give rise to a sputter-etching process in which organic impurities, in particular, are efficiently broken down. This step, as step A of the method according to the invention, has a duration of 5 min. The plasma coating is now deposited on the precleaned substrate surface in step B of the method according to the invention. For this purpose, hexamethyldisiloxane (HMDSO) having a flow rate of 66 sccm and oxygen having a flow rate of 280 sccm are introduced into the reactor. The self-bias voltage is controlled in such a way that a value of 100 V, 250 V, 300 V or 400 V is set. After a coating time of 20 min an approx. 4 μm-thick layer has deposited on the substrate, which layer greatly improves the scratch resistance and the corrosion preventiveness in relation to alkaline media: A corrosive attack of NaOH (pH 14, 5 min, 30° C.) causes no traces of corrosion that are visible to the naked eye. Coatings 1 to 3 (see Table 2), in particular, are transparent in the visible and UVA range. This is reflected in the very low absorption constant k at 300 and 400 nm respectively. The absorption constants were calculated from the ellipsometric data corresponding to the manual of the WVASE32 spectrometer from the company J.A. Woolam Co, Inc.

TABLE 2
Optical constants of the coating during variation of the BIAS voltage.

| | Self-bias | n_{250 nm} | n_{300 nm} | n_{400 nm} | k_{250 nm} | k_{300 nm} | k_{400 nm} |
|---|---|---|---|---|---|---|---|
| 1 | 100 V | 1.58 | 1.52 | 1.50 | 0.015 | 0.00 | 0 |
| 2 | 250 V | 1.62 | 1.58 | 1.54 | 0.040 | 0.01 | 0 |
| 3 | 300 V | 1.85 | 1.76 | 1.58 | 0.110 | 0.06 | 0.01 |
| 4 | 400 V | 2.20 | 1.93 | 1.85 | 0.210 | 0.12 | 0.03 |

### Exemplary Embodiment 5

A non-anodized aluminum substrate was treated by plasma polymerization under the method parameters cited in Exemplary Embodiment 2 (66 sccm HMDSO and 280 sccm O₂, self-bias=250 V). The coating was found to be more scratch-resistant than a compacted anodized coating having a layer thickness of approx. 8 μm; however, a much higher crack onset strain (greater than 2%) was observed than in an anodized coating.

An eccentric apparatus (from the company Starnberger) was used to determine the scratch resistance on the aluminum substrate. In this case, a felt platelet, which had been loaded with a weight weighing 1 kg, was used to examine an approx. 8 μm-thick anodized surface (not in accordance with the invention), an approx. 500 nm-thick plasma polymer coating produced using a prior-art method (not in accordance with the invention, produced in an exemplary manner in accordance with T. W. Jelinek, Oberflächenbehandlung von Aluminium, Eugen G. Leuze Verlag, Saulgau, 1996) and a 4 μm-thick plasma polymer coating according to the invention. The anodized surface was visually perceptibly scratched after just approx. 300 double strokes, as was the plasma polymer coating not in accordance with the invention after about 500 strokes. The plasma polymer coating according to the invention displayed no visually perceptible scratches even after 10,000 strokes.

The good corrosion prevention properties of the coating according to the invention generated by means of plasma polymerization apply both in acidic (20% sulfuric acid, 45 min, 65° C.) and in basic (NaOH, pH 14, 5 min, 30° C.) media. No visible damage or no subversion at coating edges could be ascertained after these corrosion tests.

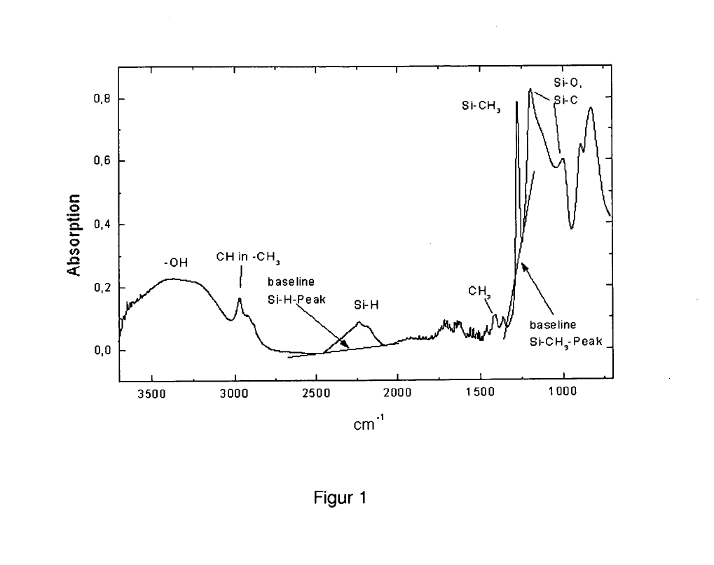

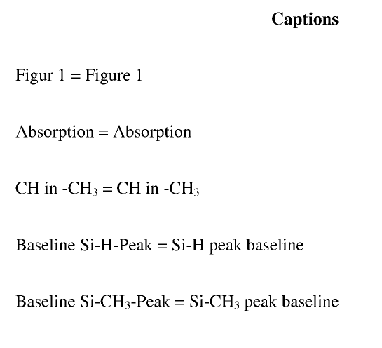

FIG. 1 shows the infrared spectrum of this coating. Clearly apparent are the CH stretching vibrations at 2,966 cm⁻¹, the Si—H vibration at 2,238 cm⁻¹, the Si—CH₂—Si vibration at approx. 1,360 cm⁻¹, the Si—CH₃ bending vibration at 1,273 cm⁻¹, the Si—O vibrations at 1,192 cm⁻¹ and 820 cm⁻¹ respectively. The band ratio (according to Example 4) between Si—H and Si—CH₃ is approx. 1:5. The IR spectrum displays a small peak at 1,360 cm⁻¹. This band is correlated with an Si—CH₂—Si vibration. In addition to the Si—O—Si network, an Si—CH₂—Si network is thus present in the coating.

The hardness of the coating was determined in accordance with Example 2. It is 3 GPa. The pencil hardness is 4H.

The coating is homogeneous in its depth. The contents of carbon are approx. 10%, of silicon approx. 10%, of hydrogen approx. 30% and of oxygen approx. 50%. A scanning electron microscopic examination of the fracture edge of the plasma polymer layer displays on the one hand a conchoidal fracture, such as is known for brittle materials (glass), and on the other hand small step-like fractures, such as are expected more for crystalline materials.

### Exemplary Embodiment 6

The experiment is carried out as in Exemplary Embodiment 5; however, a plasma generator which oscillates at a frequency of 27.12 MHz was used to increase the deposition rate and thus to shorten the process time. The deposition rate is increased by a factor of 1.5 while the gas flows (HMDSO: 66 sccm, O₂: 280 sccm) and self-BIAS voltage (250 V) remain the same. The coating properties change only slightly and are very similar to those of the coating from Exemplary Embodiment 5.

Exemplary Embodiment 7

The corrosion prevention properties of various coatings deposited on industrial, rolled aluminum 99.5 were checked in an acidic medium (20% sulfuric acid, 45 min, 65° C.).

a) Variation in self-bias (HMDSO: 45 sccm, O₂: 50 sccm)

| | | Corrosion | Si—H/Si—CH₃ band |
|---|---|---|---|
| Self-bias | Layer color | resistance | ratio |
| 50 V | Colorless | − − | 0.00 |
| 100 V | Colorless | − | 0.20 |
| 150 V | Slightly | + | 0.32 |
| | yellow | | |
| 300 V | Yellow | + + | 0.61 |

b) Variation in O₂ flow (HMDSO: 45 sccm, self-bias: 300 V)

| | | Corrosion | Si—H/Si—CH₃ band |
|---|---|---|---|
| O₂ flow | Layer color | resistance | ratio |
| 0 sccm | Yellow | ◯ | 0.61 |
| 50 sccm | Yellow | ◯ | 0.50 |
| 100 sccm | Very slightly | + + | 0.32 |
| | yellow | | |
| 150 sccm | Very slightly | + + | 0.25 |
| | yellow | | |

The corrosion resistance was evaluated using the following qualitative five-stage scale:
− − rapid, areal corrosive attack
− areal corrosive attack
◯ point-by-point corrosive attack
+ at the end of the measuring time point-by-point corrosive attack at a few locations
+ + no corrosive attack

The compromise between the layer properties may be optimized if a self-bias voltage of approx. 250 V and a ratio of O₂ to HMDSO of approx. 3:1 or greater are selected. At a ratio of O₂ to HMDSO of above 4:1, as in Exemplary Embodiment 5 for example, the coating becomes completely transparent.

Two different batches of aluminum 99.5 were used in the series of measurements specified above under a) and b). The batches may differ with regard to their content of metals other than aluminum (for example Mg, Cu); this may result in differences in corrosion resistance.

1. A method for coating the surface of a light metal substrate, including the following steps:
A. preparing the light metal substrate and optionally cleaning the substrate surface to be coated,
B. coating the substrate surface optionally cleaned in step A in a plasma polymerization reactor by means of plasma polymerization, wherein
one or more organosilicon and also (a) no further or (b) further compounds are used in step B as the precursor(s) for the plasma and
in step B the light metal substrate is arranged in the plasma polymerization reactor in such a way that it (i) is located between the zone in which the plasma is formed and the cathode or (ii) acts as a cathode,
characterized in that the method is conducted in such a way that the coating produced by the method displays
a carbon content, which can be determined by XPS measurement, of from 5 to 20 atom %, preferably 10 to 15 atom %, based on the total number of carbon, silicon and oxygen atoms contained in the coating,
a yellow index, determined in accordance with ASTM D 1925, of ≦3, preferably ≦2.5 and
a hardness, to be measured by means of nanoindentation, in the range of from 2.5 to 6 GPa, preferably 3.1 to 6 GPa.

2. The method as claimed in claim 1, wherein the light metal substrate is an aluminum or magnesium substrate.

3. The method as claimed in claim 1, wherein the method is conducted in such a way that the coating produced by the method displays a pencil hardness of 4H or more.

4. The method as claimed in claim 1, wherein in step B oxygen is supplied to the plasma and preferably all the substances supplied to the plasma in step B are gaseous before entering the plasma polymerization reactor.

5. The method as claimed in claim 4, wherein all the substances supplied to the plasma in step B are gaseous before entering the plasma polymerization reactor and the ratio of the gas flows, supplied to the plasma in step B, of oxygen and further precursor(s) is in the range of from 1:1 to 6:1, preferably 3:1 to 5:1.

6. The method as claimed in claim 1, wherein one or more siloxanes, optionally oxygen and also preferably no further compounds are used in step B as the precursor(s) for the plasma.

7. The method as claimed in claim 6, wherein hexamethyldisiloxane (HMDSO), optionally oxygen and also preferably no further compound is used in step B as the precursor(s) for the plasma.

8. The method as claimed in claim 1, wherein a control is conducted during step B, so that the self-bias is in the range of from 50 to 1,000 V, preferably in the range of from 100 to 400 V, preferably in the range of from 100 to 300 V.

9. The method as claimed in claim 1, wherein the self-bias on the substrate is set during step B.

10. The method as claimed in claim 1, wherein a control is conducted during step B, so that the self-bias is constant.

11. The method as claimed in claim 1, wherein in step B the light metal substrate is in spatial contact with (i) the cathode or (ii) a part of the cathode that is distinguishable from the aluminum substrate.

12. The method as claimed in claim 1, wherein the plasma polymerization is carried out at a temperature of less than 200° C. and/or a pressure of less than 1 mbar, preferably in the range of from 10³ to 10⁻¹ mbar.

13. The method as claimed in claim 1, wherein in step B the deposition rate is set to a value of greater than or equal to 0.2 μm/min, preferably greater than or equal to 0.3 μm/min.

14. The method as claimed in claim 1, wherein step B is carried out up to a thickness of the deposited layer of greater than or equal to 2 μm, preferably greater than or equal to 4 μm.

15. The method as claimed in claim 1, wherein the light metal substrate is an aluminum substrate selected from the group of substrates consisting of: aluminum or aluminum alloy having a cleaned, uncoated surface; aluminum or aluminum alloy having a superficial oxide layer; is anodized aluminum or aluminum alloy having a dyed or undyed, compacted or uncompacted oxide layer or a magnesium substrate selected from the group of substrates consisting of magnesium or magnesium alloys having a cleaned, uncoated surface, magnesium or magnesium alloy having a superficial oxide layer.

16. The method as claimed in claim 1, wherein in step A the substrate surface to be coated is cleaned by means of a plasma.

17. The method as claimed in claim 16, wherein in step A a gas or gas mixture is added to the plasma for carrying out the plasma cleaning, the gas or gas mixture being selected from the group consisting of: argon, argon-hydrogen mixture, oxygen.

18. The method as claimed in claim 1, wherein the method is conducted in such a way that following step B the plasma polymerization reactor contains non-fragmented organosilicon compounds which react with reactive sites at the surface of the coating so as to form a hydrophobic surface.

19. The method as claimed in claim 1, wherein the plasma is generated by means of high frequency.

20. A coated light metal substrate producible using a method according to claim 1.

21. The coated light metal substrate as claimed in claim 20, wherein the coating displays contents, which can be measured by XPS measurement, of from 5 to 30 atom %, preferably 10 to 25 atom % of silicon and 30 to 70 atom %, preferably 40 to 60 atom % of oxygen, based on the total number of carbon, silicon and oxygen atoms contained in the coating.

22. The coated light metal substrate as claimed in claim 20, wherein an IR spectrum absorbed by the coating displays one or more, preferably all the following bands having a respective maximum in the following ranges: C-H stretching vibration in the range of from 2,950 to 2,970 cm⁻¹, Si—H vibration in the range of from 2,150 to 2,250 cm¹, Si—CH₂—Si vibration in the range of from 1,350 to 1,370 cm⁻¹, Si—CH₃ bending vibration in the range of from 1,250 to 1,280 cm⁻¹ and Si—O vibration at greater than or equal to 1,150 cm⁻¹.

23. The coated light metal substrate as claimed in claim 20, wherein, in an IR spectrum absorbed by the coating, the ratio of the intensity of the Si—H band to the intensity of the Si—CH₃ band is less than or equal to 0.3, preferably less than or equal to 0.2.

24. The coated light metal substrate as claimed in claim 20, wherein the coating displays an absorption constant k_{300 nm} of less than or equal to 0.05 and/or an absorption constant k_{400 nm} of less than or equal to 0.01.

25. The coated light metal substrate as claimed in claim 20, wherein the coating displays a surface energy in the range of from 20 to 40 mN/m, preferably 25 to 35 mN/m.

26. The coated light metal substrate as claimed in claim 20, which after a 15-minute corrosive attack of NaOH at pH 13.5 and 30° C. displays no traces of corrosion that are visible to the naked eye.

27. The coated light metal substrate as claimed in claim 20, wherein the coating displays a strain to microcracking of greater than or equal to 1%, preferably greater than or equal to 1.5%.

28. The coated light metal substrate as claimed in claim 20, wherein the maximum layer thickness differs from the minimum layer thickness by a factor of 1.1 or less.

29. The use of a coating which can be produced by a method according to claim 1 as a substitute for an anodized layer.

30. The method as claimed in claim 2, wherein:
the method is conducted in such a way that the coating produced by the method displays a pencil hardness of 4H or more;
in step B oxygen is supplied to the plasma and preferably all the substances supplied to the plasma in step B are gaseous before entering the plasma polymerization reactor;
all the substances supplied to the plasma in step B are gaseous before entering the plasma polymerization reactor and the ratio of the gas flows, supplied to the plasma in step B, of oxygen and further precursor(s) is in the range of from 1:1 to 6:1, preferably 3:1 to 5:1;
one or more siloxanes, optionally oxygen and also preferably no further compounds are used in step B as the precursor(s) for the plasma;
hexamethyldisiloxane (HMDSO), optionally oxygen and also preferably no further compound is used in step B as the precursor(s) for the plasma;
a control is conducted during step B, so that the self-bias is in the range of from 50 to 1,000 V, preferably in the range of from 100 to 400 V, preferably in the range of from 100 to 300 V;
the self-bias on the substrate is set during step B;
a control is conducted during step B, so that the self-bias is constant;
in step B the light metal substrate is in spatial contact with (i) the cathode or (ii) a part of the cathode that is distinguishable from the aluminum substrate;
the plasma polymerization is carried out at a temperature of less than 200° C. and/or a pressure of less than 1 mbar, preferably in the range of from 10⁻³ to 10⁻¹ mbar;
in step B the deposition rate is set to a value of greater than or equal to 0.2 μm/min, preferably greater than or equal to 0.3 μm/min;
step B is carried out up to a thickness of the deposited layer of greater than or equal to 2 μm, preferably greater than or equal to 4 μm;
the light metal substrate is an aluminum substrate selected from the group of substrates consisting of: aluminum or aluminum alloy having a cleaned, uncoated surface; aluminum or aluminum alloy having a superficial oxide layer; is anodized aluminum or aluminum alloy having a dyed or undyed, compacted or uncompacted oxide layer or a magnesium substrate selected from the group of substrates consisting of magnesium or magnesium alloys having a cleaned, uncoated surface, magnesium or magnesium alloy having a superficial oxide layer;
in step A the substrate surface to be coated is cleaned by means of a plasma;
in step A a gas or gas mixture is added to the plasma for carrying out the plasma cleaning, the gas or gas mixture being selected from the group consisting of: argon, argon-hydrogen mixture, oxygen;
the method is conducted in such a way that following step B the plasma polymerization reactor contains non-fragmented organosilicon compounds which react with reactive sites at the surface of the coating so as to form a hydrophobic surface; and
the plasma is generated by means of high frequency.

31. A coated light metal substrate producible using a method according to claim 30.

32. The coated light metal substrate as claimed in claim 22, wherein:
in an IR spectrum absorbed by the coating, the ratio of the intensity of the Si—H band to the intensity of the Si—CH₃ band is less than or equal to 0.3, preferably less than or equal to 0.2;
the coating displays an absorption constant k_{300 nm} of less than or equal to 0.05 and/or an absorption constant k_{400 nm} of less than or equal to 0.01;
the coating displays a surface energy in the range of from 20 to 40 mN/m, preferably 25 to 35 mN/m;
after a 15-minute corrosive attack of NaOH at pH 13.5 and 30° C. it displays no traces of corrosion that are visible to the naked eye;
the coating displays a strain to microcracking of greater than or equal to 1%, preferably greater than or equal to 1.5%; and
the maximum layer thickness differs from the minimum layer thickness by a factor of 1.1 or less.

33. The use of a coating which can be produced by a method according to claim 30 as a substitute for an anodized layer.
